(19) United States
(12) Patent Application Publication
(10) Pub. No.: US 2022/0026004 A1
(43) Pub. Date: Jan. 27, 2022

(54) QUICK CONNECT SYSTEM AND METHOD

(71) Applicant: Enerco Group, Inc., Cleveland, OH (US)

(72) Inventor: Brian S. Vandrak, Highland Heights, OH (US)

(73) Assignee: Enerco Group, Inc., Cleveland, OH (US)

(21) Appl. No.: 16/935,383

(22) Filed: Jul. 22, 2020

(51) Int. Cl. F16L 37/35

(52) U.S. Cl. CPC F16L 37/35; F16L 37/23

(57) ABSTRACT

One or more techniques and/or systems are disclosed provide for a user device merely fluidly coupling with an appropriately matched, target fuel source. The user device can use complementary-keyed connectors to provide for desired user devices coupling merely with desired, target fuel sources. To accomplish this, a male connector may be configured with a keyed feature, and a female connector may be configured with a keyed location complementary to the keyed feature of the male connector.

### BACKGROUND

Many user devices utilize gas fuel sources. A fuel source may be connected to a user device using a series of connectors, sometimes referred to as quick connects. The connectors (e.g., quick connects) may allow a user to easily connect or disconnect a fuel source to a user device.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein are provided that can be used to help a user connect a user device to a matching fuel source. In one implementation the user device and a corresponding fuel source may utilize complementary, keyed connectors to provide for user devices to be connected merely to appropriate fuel sources. In this example, a male connector may have a keyed feature and a female connector may have a complementary keyed location to engage the keyed feature of the male connector. Further, in this implementation, the keyed feature/location may ensure that the male connector may be connected merely to a female connector having a keyed location that corresponds to the keyed feature of the male connector, and also provide for an appropriate gas coupling connection. By providing a system that mitigates the coupling of the male and female connectors to non-complementary connectors (e.g., foreign connectors without matching keyed feature or location, etc.), the techniques or systems describe herein may mitigate user devices from being improperly connected to improper or foreign fuel sources.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating a side view of an exemplary embodiment of a male connector that may be used in the manner described herein.

FIG. 2 is a component diagram illustrating a front view of an exemplary embodiment of a male connector that may be used in the manner described herein.

FIG. 3 is a component diagram illustrating a side view of an exemplary embodiment of a female connector that may be used in the manner described herein.

FIG. 4 is a component diagram illustrating a front view of an exemplary embodiment of a female connector that may be used in the manner described herein.

FIG. 5 is a component diagram illustrating a cut-away view of an exemplary embodiment of a male connector that may be used in the manner described herein.

FIG. 6 is an exemplary embodiment of a male connector and a female connector in an unconnected state.

FIG. 7 is an exemplary embodiment of a male connector and a female connector in a connected state.

FIG. 8 is a component diagram illustrating a cut-away view of an exemplary embodiment of a male connector that may be used in the manner described herein.

FIG. 9 is a component diagram illustrating a cut-away view of an exemplary embodiment of a male connector including additional components shown therein.

FIG. 10 is a component diagram illustrating a cut-away view of an exemplary embodiment of a female connector that may be used in the manner described herein.

FIG. 11 is a component diagram illustrating a cut-away view of an exemplary embodiment of a female connector including additional components shown therein.

FIGS. 12 and 13 are component diagrams illustrating exemplary embodiments of a spool that may be used in a manner described herein.

FIGS. 14-16 are component diagrams illustrating exemplary embodiments of a retainer that may be used in a manner described herein.

FIGS. 17 and 18 are component diagrams illustrating exemplary embodiments of a grip for a connector that may be used in a manner described herein.

FIGS. 19 and 20 are component diagrams illustrating exemplary embodiments of a slide for a connector that may be used in a manner described herein.

FIGS. 21 and 22 are component diagrams illustrating exemplary embodiments of a spring that may be used in a manner described herein.

FIGS. 23 and 24 are component diagrams illustrating exemplary embodiments of another spring that may be used in a manner described herein.

FIGS. 25-27 show exemplary embodiments of a male and a female connector as described herein.

FIGS. 28-30 show exemplary embodiments of a male and a female connector as described herein.

FIGS. 31-34 show exemplary embodiments of a cooking device that may utilize aspects of the male and female connectors as described herein.

FIGS. 35 and 36 show exemplary embodiments of a heater device that may utilize aspects of the male and female connectors as described herein.

FIG. 37 is a component diagram illustrating an example implementation of one or more portions of one or more systems described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As an example, a user device may utilize a connection to a gas fuel source for power. The user device may also utilize a gas fuel source that has desired and specific properties (e.g., type of fuel, pressure, output, tank size, etc.) to operate appropriately (e.g., correctly and efficiently). Often, a fuel source is connected to a user device with a fuel line. The fuel line may be attached to both the user device and the fuel source using connectors (e.g., quick connects, etc.). With the use of quick connects, for example, a user may quickly connect or disconnect a user device to a fuel source. Similar quick connects may be used for a variety of different types, devices, fuel sources, tools, appliances, industries, etc. For this reason, it may be possible to inadvertently (e.g., or purposefully) couple a user device to a fuel source or other device that is inappropriate for the intended use (e.g., may not provide a full or desired seal for gas flow, or made lead to device damage). Connecting a user device to an improper or unmatched fuel source or other device may cause the user device to function poorly, leak, or may cause damage to the user device.

To provide for a desired coupling of a target fuel source to a user device, specialized connectors may be used. In an example, a male connector corresponding to a user device may be configured to appropriately couple with a complementary female connector of the desired, target fuel source. In another example, a female connector corresponding to a user device may be configured to appropriately couple with a complementary male connector of a desired, target fuel source. In yet another example, a fuel line may be used with the male and female connectors described above to connect a desired, target fuel source to a target user device.

By way of example, user devices may include heaters, grills, cooking devices, lights, tools, or other devices that utilize a liquid or gas fuel source for power. Fuel sources may include propane tanks, natural gas tanks, butane tanks, or tanks with mixtures thereof, compressed air, or any other liquid or gas fuels.

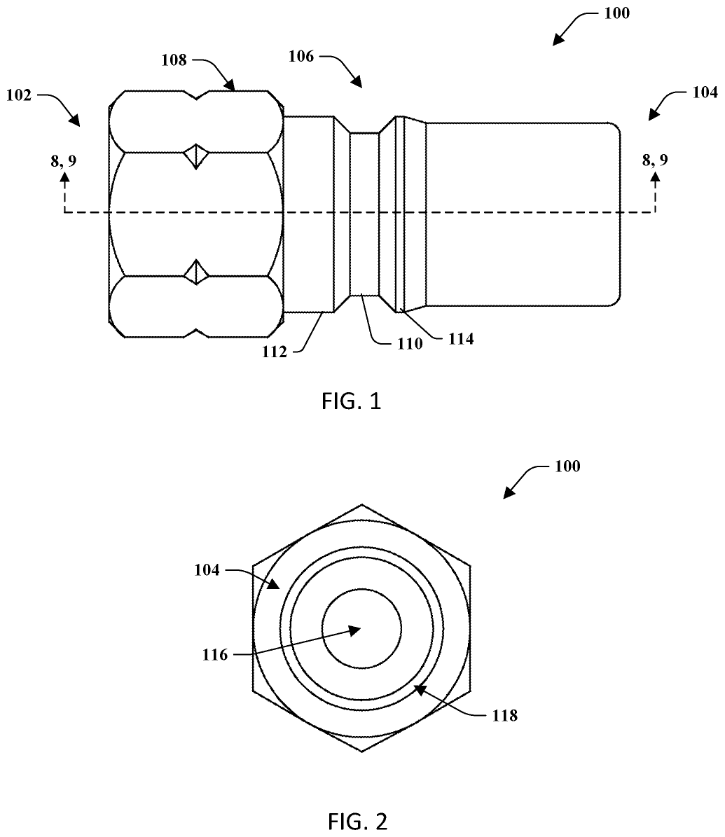

FIGS. 1-11 illustrate exemplary embodiments of a male connector 100 and a female connector 200. Male connector 100 and female connector 200 may be used to couple a corresponding user device to an appropriately matched fuel source (e.g., to ensure that a desired fuel source is connected to a user device). In an example, the male connector 100 and the female connector 200 may be configured to couple appropriately to one another and may also mitigate improper coupling of other non-conforming (e.g., foreign) connectors. The male and female connectors 100, 200 may be manufactured such that the male connector 100 includes a keyed feature that engages a complementary keyed location of the female connector 200. For example, the male connector 100 may couple appropriately with a properly-matched keyed feature when inserted into a female connector 200 with a complementary keyed location.

In an example, a male connector 100 and a female connector 200 may be matched or keyed for one another by matching a keyed feature of the male connector 100 to a keyed location of the female connector 200. The keyed feature of the male connector 100 and the keyed location of the female connector 200 may be matched according to shape and size, providing a complementary fit. For example, the female connector 200 may include a keyed location that only a male connector 100 having a complementary keyed feature may fit in. Connectors lacking a matching keyed feature or keyed location may not properly couple with connectors having none or different keyed features or keyed locations. In one example, the keyed feature and keyed location may be circular in shape. In another example the keyed feature and keyed location may be substantially straight. In yet another example, the keyed feature and keyed location may be an alternate complementary shape. It should be appreciated that keyed features and keyed locations of any shape, size, orientation, etc. may be used.

FIG. 1 illustrates an exemplary embodiment of a male connector 100 that may be configured to fit (e.g., match, etc.) in a coupled arrangement with a complementary female connector 200. The male connector 100 may have a first end 102, a second end 104, and a body 106 disposed between the first end 102 to the second end 104. The first end 102 may comprise a grip section 108 that may be used to grip the connector 100, such as by hand or a complementary tool. The body 106 may include a notch 110 positioned between the first end 102 and the second end 104. The notch 110 may be formed from ridges 112 and 114 positioned on either side of the notch 110. The male connector 100 may further comprise a keyed feature 118 respective to the second end 104.

Turning to FIG. 2, a front view of the male connector 100 is shown. The male connector may comprise a through passage 116 extending between the connector 100 from the first end 102 to the second end 104. The male connector 100 may also comprise a keyed feature 118 disposed proximate to the second end 104. Keyed feature 118 may be configured to match a complementary keyed location of female connector 200. It will be appreciated that keyed feature 118 may be circular, as shown in FIG. 2, or may be any shape, size, or configuration as determined by sound engineering judgment.

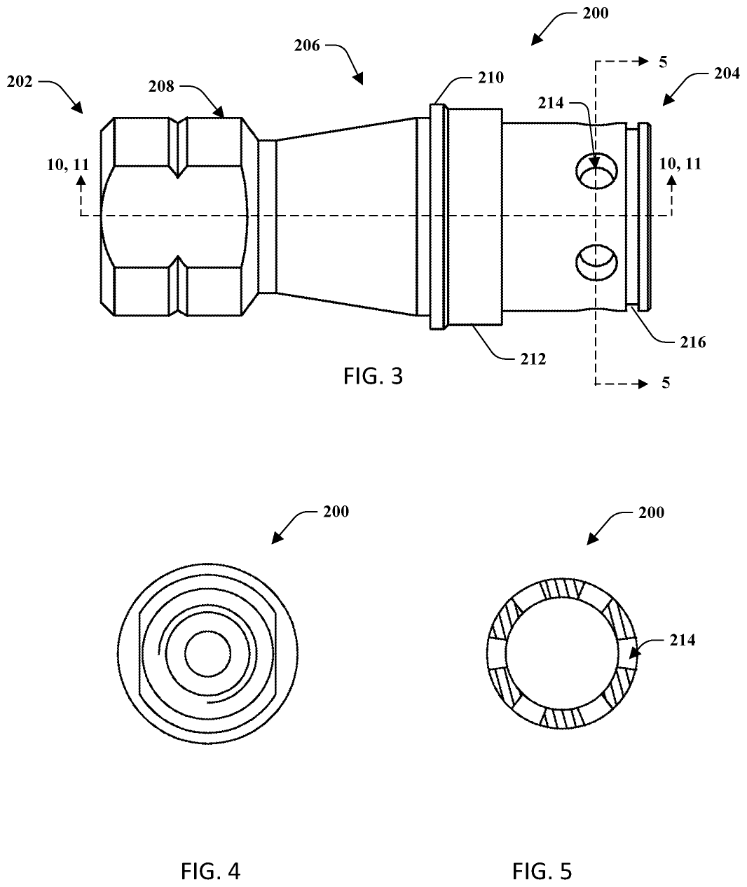

FIG. 3 illustrates an exemplary embodiment of a female connector 200 that may be configured to fit a complementary male connector 100. The female connector 200 may have a first end 202, a second end 204, and a body 206 extending between the first end 202 and the second end 204. The first end 202 may include a grip section 208 that may be used to grip the connector 200, such as by hand or a tool. The body 206 may comprise a rib 210 positioned between the first end 202 and the second end 204, and extending around the circumference of the body 206. The female connector 200 may also comprise holes 214 in the body 206 of the connector 200, evening spaced around the circumference of the body 206. A notch 216 may be disposed in (e.g., manufactured into) the body 206 of the connector 200 respective to the second end 204 and extending around the circumference of the body 206. The female connector 200 may also comprise a keyed feature (not shown) within the body 206 of the female connecter 200, such as proximate the second end.

Turning to FIG. 4, a front view of female connecter 200 is shown. FIG. 5 illustrates a cut-away view of female connector 200 taken about line 5-5 of FIG. 3.

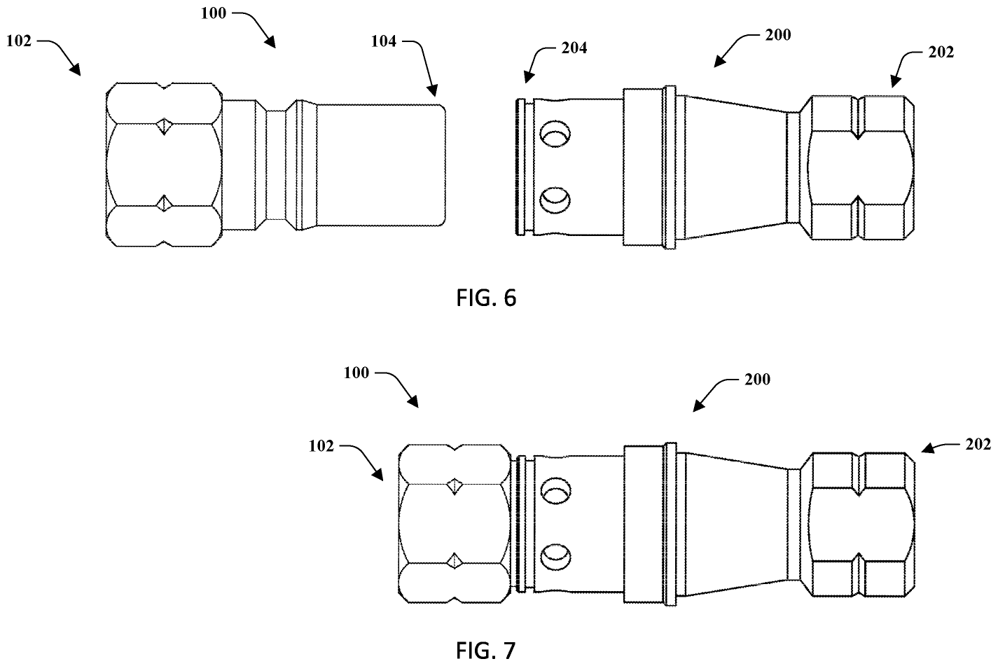

Turning to FIGS. 6 and 7, connectors 100 and 200 are shown in a detached state (FIG. 6) and an attached state (FIG. 7). In an example, male connector 100 may be inserted into female connector 200 by inserting the second end 104 of the male connector 100 into the second end 204 of the female connector 200. A keyed feature 118 of the male connector 100 may correspond to a like (e.g., a complementary) keyed location (not shown) of the female connector 200. This may facilitate coupling the matching male connectors, such that other non-conforming connectors may not be appropriately coupled (e.g., but may be inserted) with the complementary female connectors.

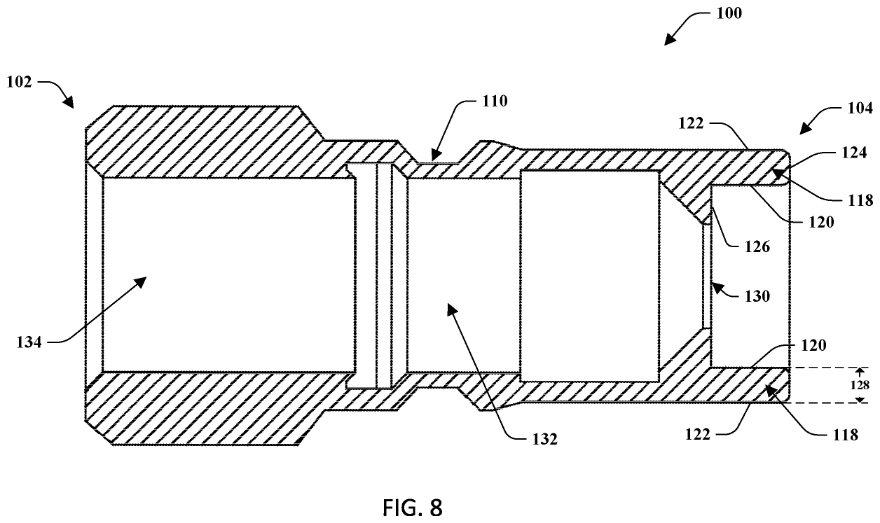

Turning to FIG. 8, a cross-sectional view of male connector 100 is shown taken from line 8-8 of FIG. 1. Details of the keyed feature 118 are shown and may be more readily apparent from the cross-sectional view. In an example, keyed feature 118 is formed by an inner surface 120, an outer surface 122, and an outer edge 124 of the connector 100, as shown in FIG. 8. A second inner surface 126 may further form the keyed feature 118. The thickness 128 of the keyed feature 118 may be shown as the distance between inner surface 120 and outer surface 122. Further, the thickness 128 of the keyed feature 118 may correspond to a thickness of a complementary keyed location of female connector 200.

Male connector 100 may further include an opening 130 in the second inner surface 126, relative the second end 104. The opening 130 may define a front portion of cavity 132 of the connector 100. A fluid (e.g., such as a gas), for example, may pass through the opening 130 into (e.g., or out of) the cavity 132 and out (e.g., or into) opening 134 relative to the first end 102 of the male connector 100.

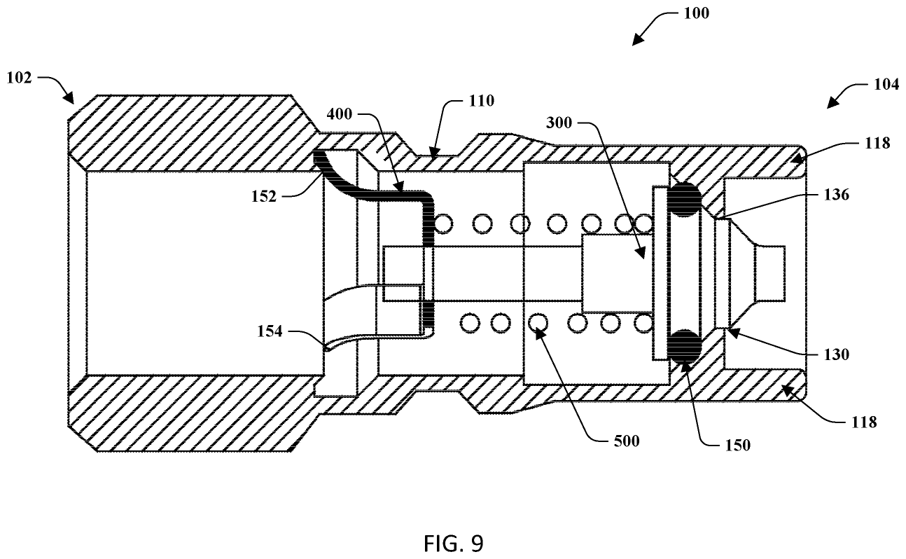

Turning to FIG. 9, a cross-sectional view of male connector 100 taken from line 9-9 of FIG. 1 is shown. FIG. 9 is substantially similar to FIG. 8 with the addition of a number of features. For example, male connector 100 may include a spool 300 inserted into the cavity 132 and protruding through opening 130. The spool 300 may be held in position with mount 400. The retainer 400 may rest against connector 100 at locations 152 and 154. The connector 100 may further include a spring 500 to bias the spool against the male connector 100 at location 136. For example, spool 300 may move between a first position (closed) to a second position (open). In the first position (as illustrated in FIG. 9), spool 300 may be biased against the location 136 and/or an O-ring 150 to prevent fluid from flowing through opening 130. In the second position, spool 300 may be positioned away from the location 136 and O-ring 150 to allow fluid to flow through opening 130. By adjusting the position of the spool 300 between the first and the second position, fluid flow though the male connector 100 may be controlled (e.g., blocked/closed or allowed/open). O-ring 150 may be installed between the spool 300 and the connector 100 to increase the effectiveness of the seal at location 136.

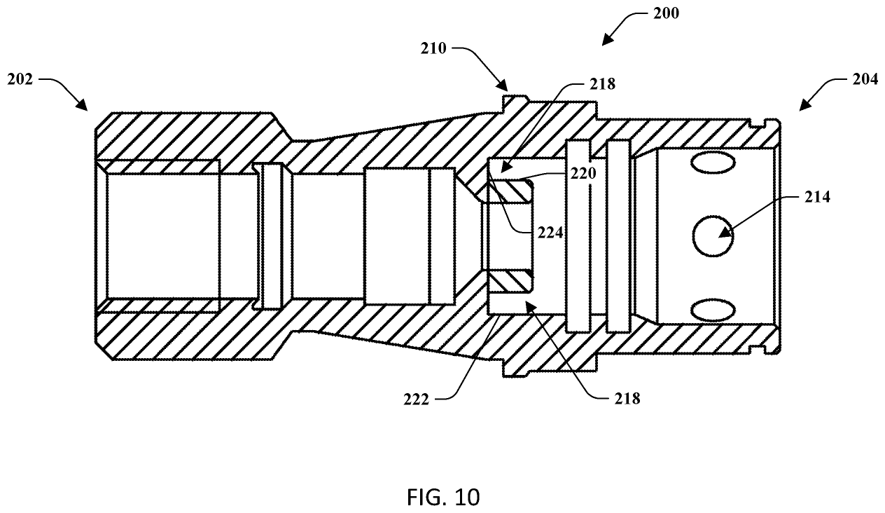

Turning to FIG. 10, a cross-sectional view of female connector 200 taken about line 10-10 of FIG. 3 is shown. Female connector 200 may include a keyed location 218. In an example, the keyed location 218 may operably engage with keyed feature 118 of male connector 100. The shape and design of the keyed location 218 of the female connecter 200 may be complementary in shape, size, and design of the keyed feature 118 such that keyed feature 118 may appropriately couple with keyed location 218.

The surfaces of the keyed feature 118 of the male connector 100 may correspond and be complementary to like surfaces of the keyed surface 218 of the female connector 200. For example surface 124 of the male connector 100 may be complementary to and rest against surface 224 of the female connector 200 (e.g., when male connector 100 is inserted into female connector 200). Further surfaces 120 and 122 of the male connector 100 may be complementary to and rest against surface 220 and 222 of the female connector 200.

In an example, keyed feature 118 of the male connector 100 may be complementary/correspond to keyed feature 218 of the female connector 200. This may allow a male connector 100 to match a female connector 200 to create an appropriate fluid coupling between the connectors. The complementary connection may prevent a user from appropriately coupling a foreign male connector to the female connector 200 or from connecting a foreign female connector to the male connector 100. For example, by preventing the connection to foreign connectors, the system described herein may also prevent a user device from being connected to a foreign (non-matching) fuel source, which could lead to fluid leakage, and/or device damage. This may be accomplished by using male connector 100 and female connector 200 on matching user devices and fuel devices.

In another example, male connector 100 and female connector 200 can be help appropriately couple (e.g., fluidly couple) a user device to an appropriately matching (e.g., desired), target fuel source. The user device may be equipped with a female connector 200 and the fuel source may be equipped with the male connector 100. In this example, the male connector 100 and the female connector 200 may have a complementary configured keyed feature 118 and keyed location 218, respectfully. Therefore, in this example, in order to create an appropriate coupling (e.g., so that fluid flows between, and does not leak in an undesired manner) the male connector 100 and the female connector 200 may be coupled with each other (e.g., the connectors may not allow a full sealed connection to a foreign connector). Thus, for example, the user device with female connector 200 may only be fully and fluidly coupled to a fuel source having the complementary male connector 100.

In yet another example, a fuel line may be used to fluidly couple a user device to a fuel source. As an example, the user device may be equipped with a female connector 200 and the fuel source may be equipped with the male connector 100. The male connector 100 and the female connector 200 may have a complementary keyed feature 118 and keyed location 218, as described herein, respectfully. In this example, the fuel line may have a male connector 100 on a first end and a female connector 200 on a second end. As in the previous example, male connector 100 and female connector 200 may only be appropriately coupled with each other (e.g., the connectors will not allow complete and appropriate connection to foreign connectors). Thus, user device with female connector 200 can merely form an appropriate coupling to a fuel line having a male connector 100, and the fuel line may then only form an appropriate coupling to a fuel source having a male connector 100 as well. In this way, for example, only those user devices, fuel lines, and fuel sources having complementary connector may be used to form an appropriate fluid coupling. In this way, for example, a user may not connect a user device to an incorrect (e.g., non-matching) fuel source, which could result in leakage and/or damage to the device, fuel line, and/or fuel source.

Turning to FIG. 11, a cross-sectional view of female connector 200 taken from line 11-11 of FIG. 3 is shown. FIG. 11 is substantially similar to that found in FIG. 10 with the addition of a number of features. For example, female connecter 200 may include a retainer 400, a spring 500, a spool 600, a spring 700, and a slide 800. Female connector 200 may also include a number of O-rings 250, 252, and 254. Fluid may flow through the female connecter 200 from opening 234, through cavity 232, and out opening 238, for example.

Retainer 400 may be configured to hold the spool 600 in place within the cavity 232 of the female connector 200. Spring 500 may bias the spool 600 against female connector 200 at location 236 to mitigate fluid flow through the opening 230. Spool 600 may rest against O-ring 250 to provide an effective seal against location 236. For example, spool 600 may move between a first position (e.g., closed) to a second position (e.g., open). In the first position (e.g., as illustrated in FIG. 11), spool 600 may be biased against the location 236 and/or the O-ring 250 to mitigate fluid from flow through opening 230. In the second position, spool 600 may be positioned away from the location 236 and O-ring 250 to allow fluid flow through opening 230. By adjusting the position of the spool 600 between the first and the second position, fluid flow though the female connector 200 may be controlled (e.g., blocked/closed, allowed/open).

Female connector 200 may include a slide 800. The slide 800 may be used to selectably secure and/or release the male connector 100 to the female connector 200 by sliding between a first location (e.g., illustrated in FIG. 11) and a second location (not shown). For example, the female connector 200 may include ball bearings (not shown) positioned within openings 214. The slide 800 may engage the ball bearings (not shown) in openings 214 such that when the slide 800 is in the first position the ball bearings (not shown) are forced towards the center of the female connector 200 (e.g., in a direction away from the slide 800 toward the center of the female connector 200). Further, when the slide 800 is in the second position, the ball bearings (not shown) may be allowed to move away from the center of the female connector 200 to allow the male connector 100 to be inserted into the female connector 200. When the slide 800 is placed into the first position the ball bearings (not shown) may engage with notch 110 of the male connector 100 to hold the male connector 100 in place within the female connector 200.

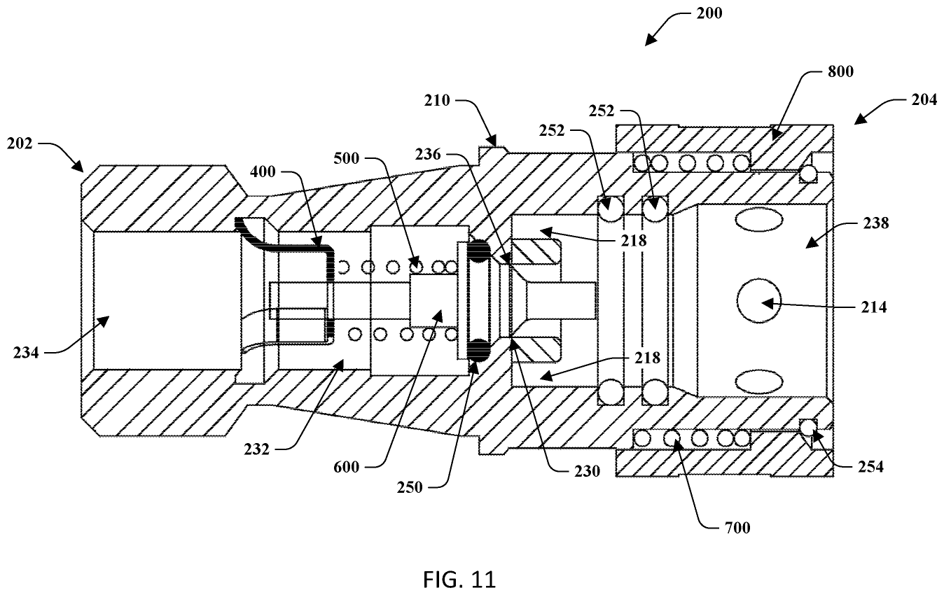

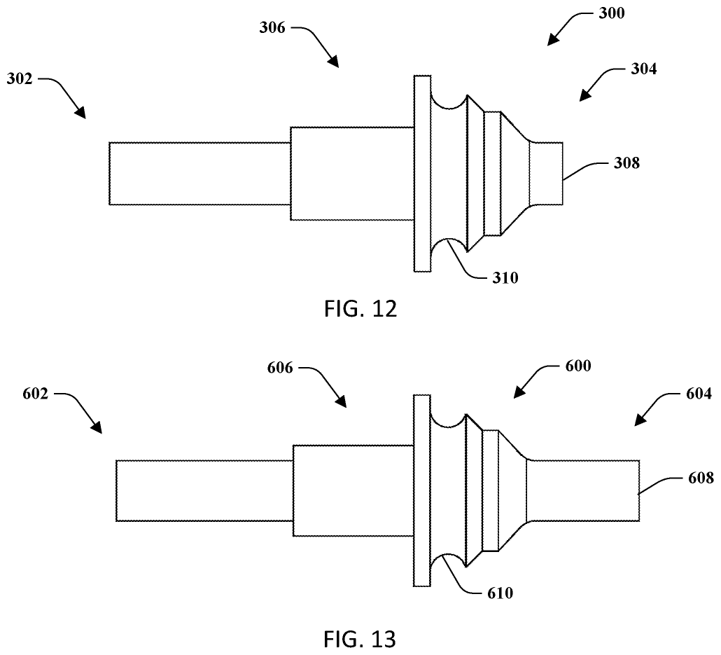

Turning to FIGS. 12 and 13, exemplary embodiments of spools 300 and 600 are shown. Male connector 100 may include a spool 300 and female connector 200 may include spool 600. Spool 300 may include a first end 302, a second end 304, and a body 306. Spool 300 may further include a location 310 for an O-ring (not shown) and a surface 308 disposed proximate the second end 304. Similarly, spool 600 may include a first end 602, a second end 604, and a body 606. Spool 600 may further include a location 610 for an O-ring (not shown) and a surface 608 disposed proximate the second end 604.

In an example, surface 308 of spool 300 may engage surface 608 of spool 600 when the male connector 100 is coupled with the female connector 200. For example, when the male connector 100 is fully inserted into the female connector 200 and surfaces 308 and 608 are engaged, spool 300 may compress spring 500 of the male connector 100 and spool 600 may compress spring 500 of the female connector 200. Further, spool 300 may move away from location 136 and spool 600 may move away from location 236 to allow fluid to flow through openings 130 and 230. Thus, when male connector 100 is fully inserted into female connector 200, fluid may flow freely between male connector 100 and female connector 200.

By way of example, a foreign connector (e.g., a connector without a complementary keyed feature or location) may not be fully coupled with (e.g., inserted into) a female connector 200. Because the connector may not be fully coupled with the female connector 200, for example, fluid may not flow freely because spool 300 and spool 600 may be still biased against locations 136 and 236 respectively. In addition to mitigating fluid flow, ball bearings (not shown) fitted in openings 214 may not appropriately engage a notch (e.g., 110) of a foreign male connector that lacks the unique keyed feature complementary to a female connector 200.

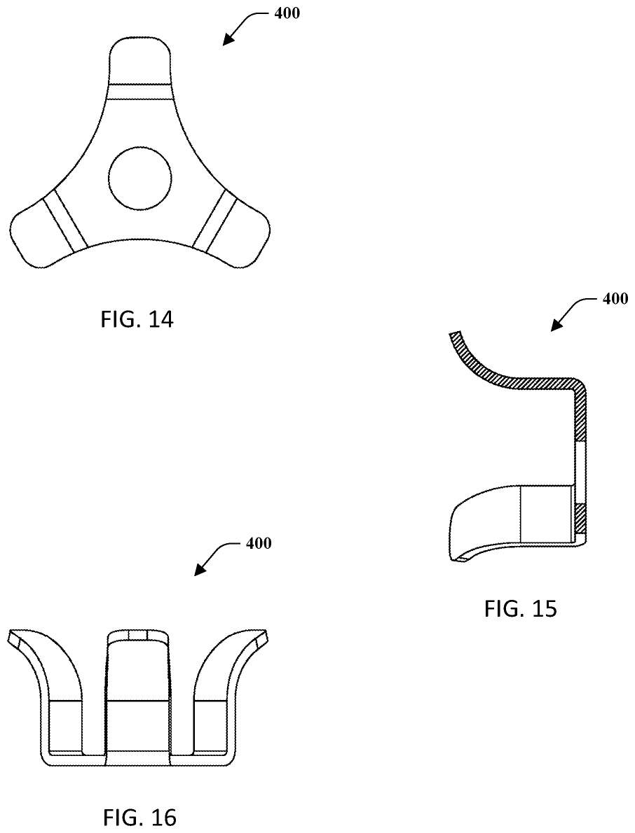

Turning to FIGS. 14-16, an exemplary embodiment of retainer 400 is shown. Retainer 400 may be used to hold spool 300 in place within male connector 100 or hold spool 600 in place within female connector 200.

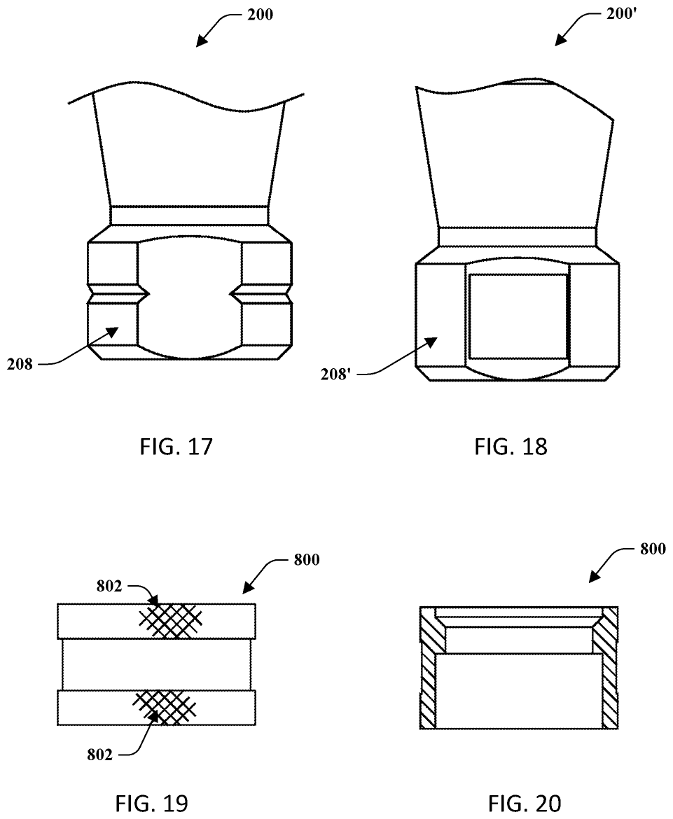

Turning to FIGS. 17 and 18, the grip 208 of the female connector 200 is shown in greater detail. FIG. 18, is an alternate embodiment 200′ of the female connector 200. The connector 200′ is shown with an example embodiment of the grip section 208′, similar to the grip 208 of the female connector 200.

Turning to FIGS. 19 and 20, an exemplary embodiment of slide 800 is shown. Slide 800 may include a grip section 802 to allow a user to grip the slide 800 more effectively. By way of example, a user may move slide 800 along the female connector 200 to couple or decouple male connector 100.

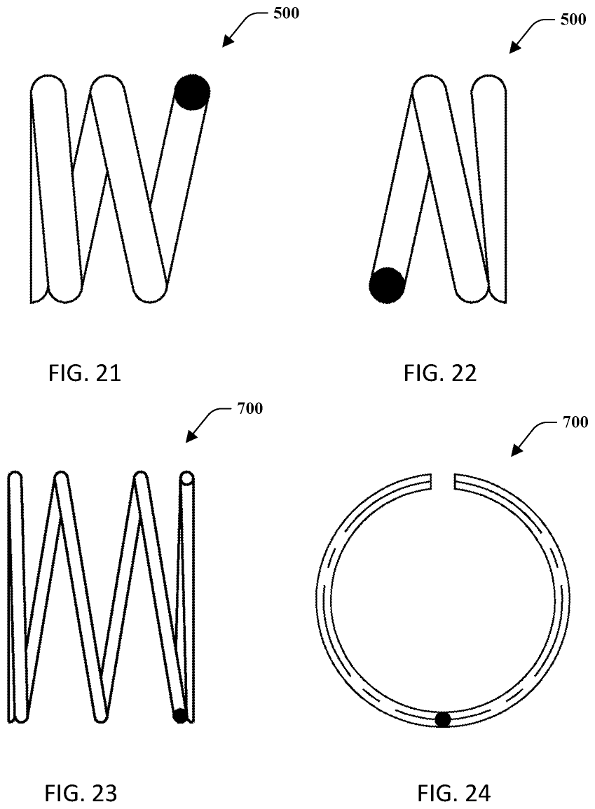

Turning to FIGS. 21 and 22, an exemplary embodiment of spring 500 is shown. Spring 500 may be uses in male connector 100 or female connector 200 to bias spools 300 and 600 against surfaces 136 and 236, respectively. Spring 500 may be formed of any suitable material, such as metal or polymer.

Turning to FIGS. 23 and 24, an exemplary embodiment of spring 700 is shown. Spring 700 may be used to bias slide 800 against O-ring 254 in female connector 200, for example. Spring 700 may be formed of any suitable material, such as metal or polymer.

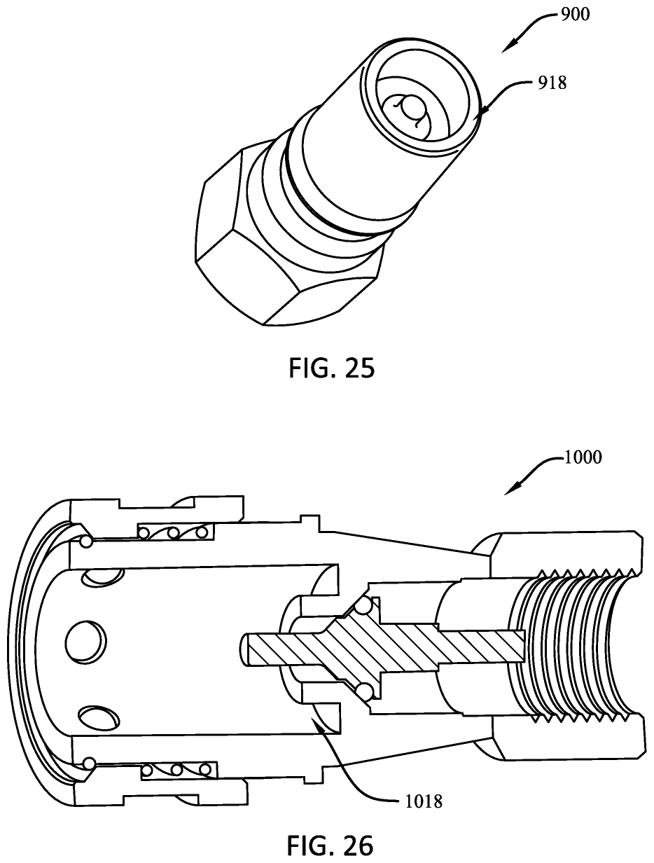

Turning to FIGS. 25-27, exemplary embodiments of a male connector 900 and a female connector 1000 are shown. Male connector 900 and female connector 1000 are substantially similar to male connector 100 and female connector 200, respectfully, except for any differences described herein. Male connector 900 may include a keyed feature 918 to engage a keyed location 1018 of the female connector 1000. In this example, the keyed feature 918 and keyed location 1018 may be circular in shape. It should be appreciated, however, that a keyed feature and complementary keyed location may be any suitable shape or size.

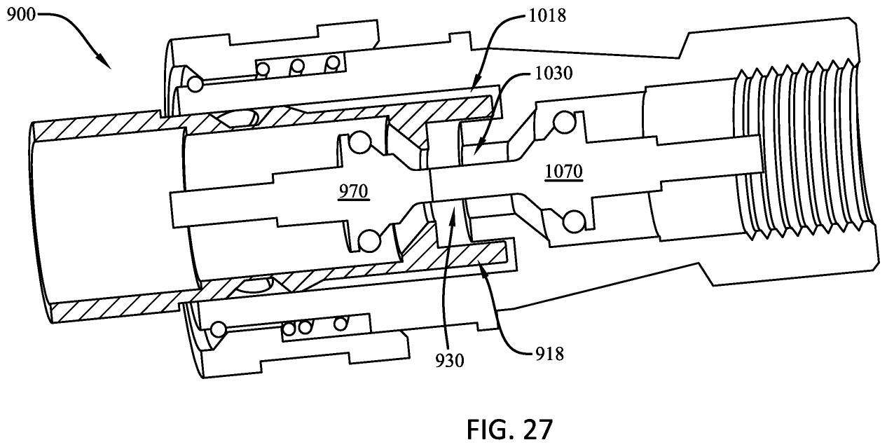

FIG. 27 is a cutaway view of male connector 900 that is fully coupled with (e.g., inserted into) female connector 1000. As illustrated in FIG. 27, the keyed feature 918 of the male connector 900 may engage with a keyed location 1018 of the female connector 1000 to allow the male connector 900 to be fully coupled with the female connector 1000. In an example, while fully coupled with the female connector 1000, the spool 970 of the male connector 900 may engage the spool 1070 of the female connector 1000 allowing fluid to flow through openings 930 and 1030 of male connector 900 and female connector 1000, respectively. It should be appreciated that merely those connectors having the complementary keyed feature or keyed location may be fully coupled (e.g., male connector fully inserted into female connector). Foreign male connectors, for example, may not insert fully into complementary-keyed female connector 1000. Therefore, spools 970 and/or 1070 may not engage each other to provide an opening (e.g., 930, 1030) for fluid to flow.

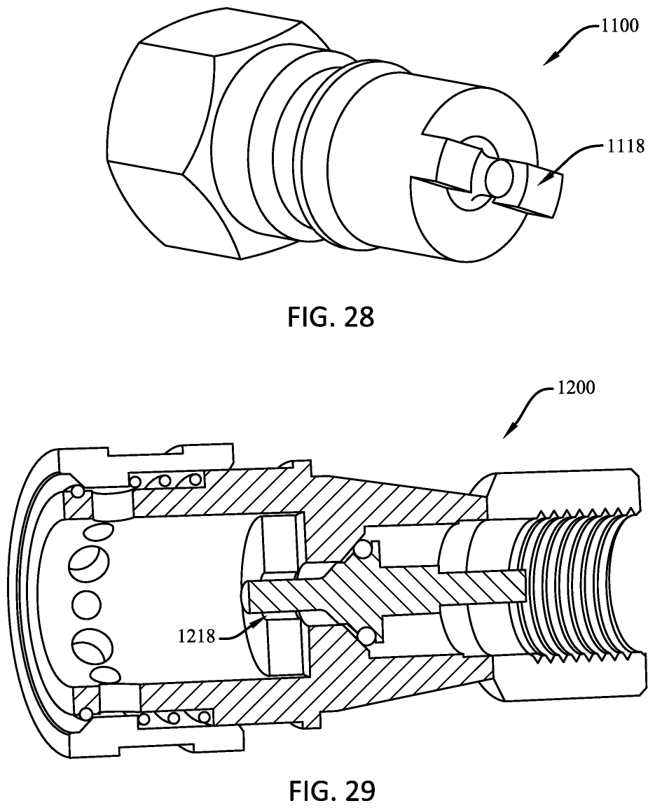

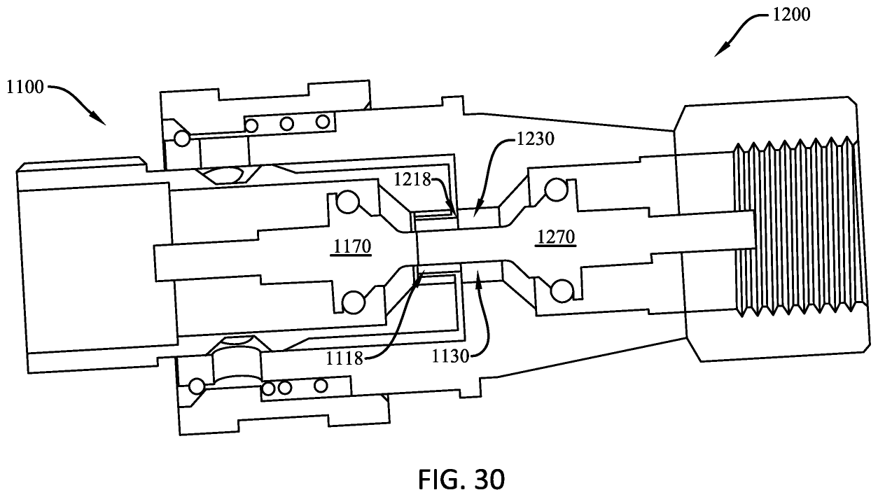

Turning to FIGS. 28-30, other exemplary embodiments of a male connector 1100 and female connector 1200 are shown. Male connector 1100 and female connector 1200 are substantially similar to male connector 100 and female connector 200, respectfully, except for any differences described herein. Male connector 1100 may include a keyed feature 1118 to engage a keyed location 1218 of the female connector 1200. In this example, the keyed feature 1118 and keyed location 1218 may be substantially straight in shape. It should be appreciated, however, that a keyed feature and complementary keyed location may be any suitable shape or size.

FIG. 30 is a cutaway view of male connector 1100 that is fully coupled with (e.g., inserted into) female connector 1200. As illustrated in FIG. 30, the keyed feature 1118 of the male connector 1100 may engage with a keyed location 1218 of the female connector 1200 to allow the male connector 1100 to be fully coupled with the female connector 1200. In an example, while fully coupled with the female connector 1200, the spool 1170 of the male connector 1100 may engage the spool 1270 of the female connector 1200 allowing fluid to flow through openings 1130 and 1230 of male connector 1100 and female connector 1200 respectively. It should be appreciated that only connectors having the complementary keyed feature or keyed location may be fully coupled (e.g., male connector fully inserted into female connector). Foreign male connectors, for example, may not couple fully with complementary keyed female connector 1200. Therefore, spools 1170 and/or 1270 may not engage each other to provide an opening (e.g., 1130, 1230) for fluid to flow.

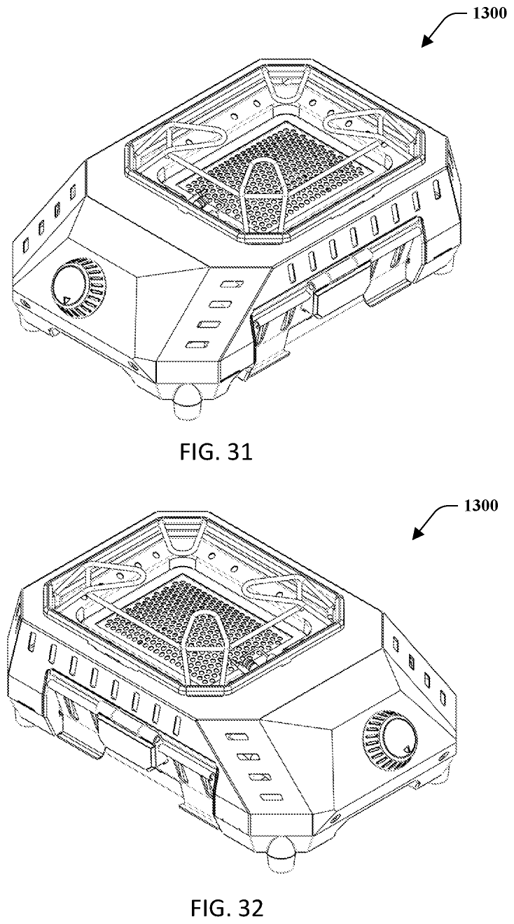

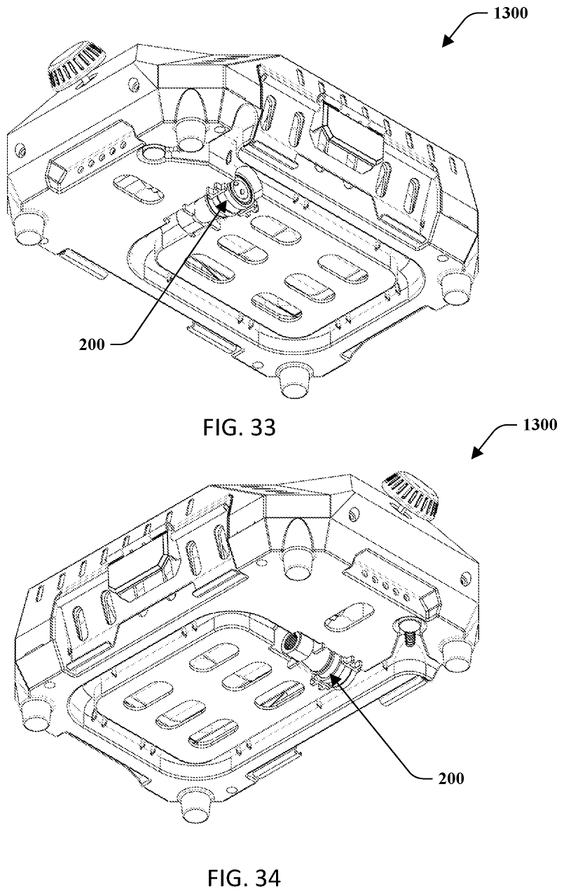

Turning to FIGS. 31-34, an exemplary user device 1300 is shown. User device 1300 may be a propane-fueled cooking device, for example. To mitigate improper coupling attempts, such as a user connecting user device 1300 to a foreign or improper fuel source, a female connector 200 may be used. By way of example, a fuel source may be coupled with a user device 1300 using a female connector 200 (e.g., as installed on user device 1300) and a male connector 100 installed on a desired fuel source. In another example, a fuel line equipped with a male connector 100 and a female connector 200 may be used as well. It should also be appreciated that although the example is shown using female connector 200, other embodiments of female connectors with keyed locations may be used (e.g., female connector 1000 or 1200, etc.).

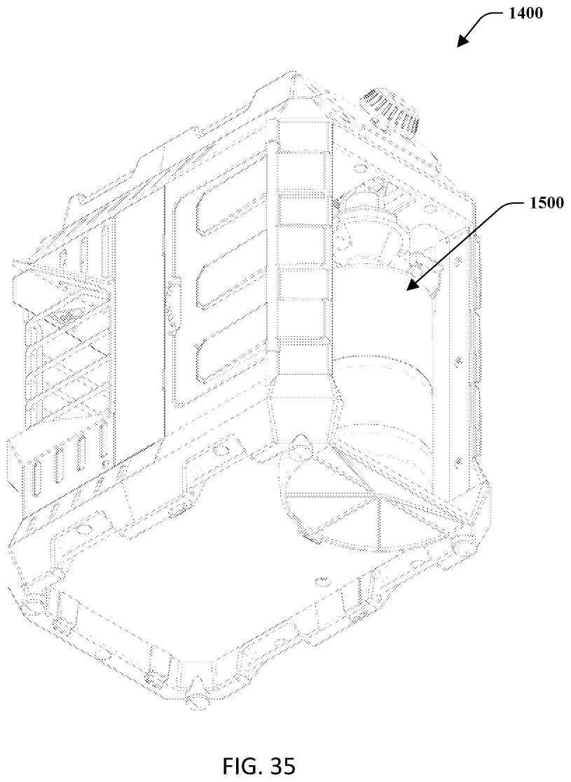

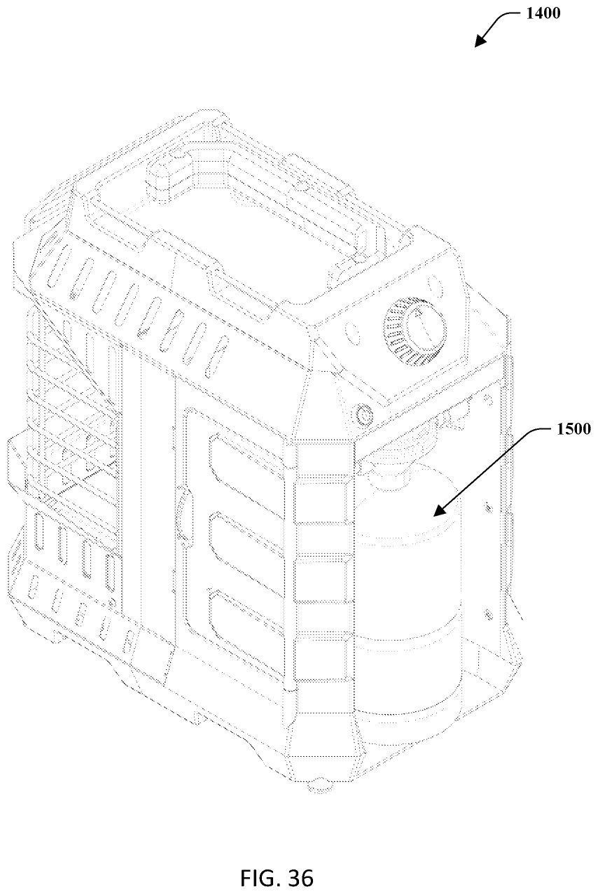

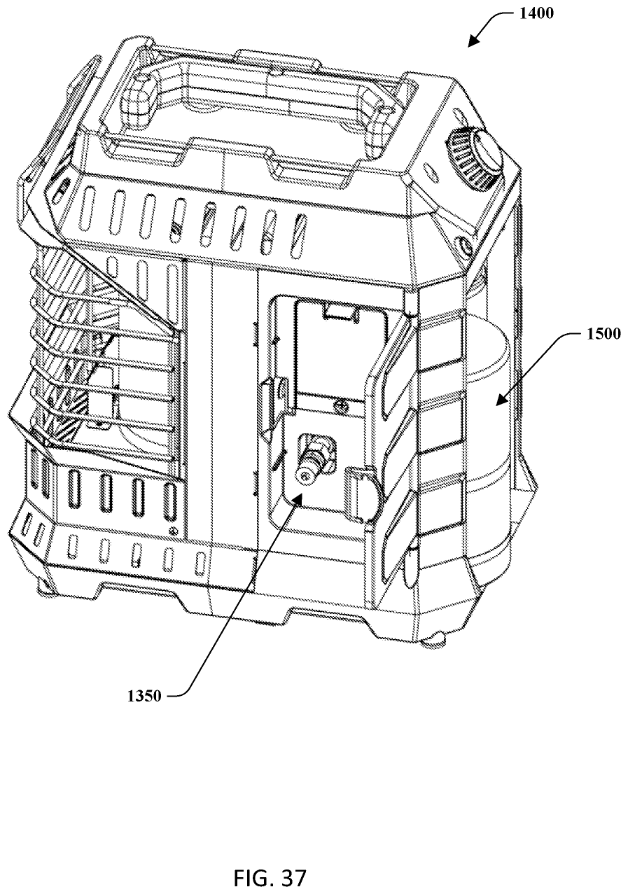

Turning to FIGS. 35, 36, and 37 another exemplary user device 1400 is shown. User device 1400 may be a propane-fueled (e.g., or other appropriate pressurized liquid fuel, such as butane, natural gas, or the like) heater, for example. In this example, the device 1400 can be configured to couple with a fuel source 1500, such as a tank, bottle, hose, or the like. As an example, a one-pound propane cylinder can be coupled to the device 1400, such as by threading the tank to a coupler. Further, in this example, the device 1400 can comprise an accessory device coupling 1350 that is configured to couple to an accessory, such as using a fuel hose. For example, to mitigate inappropriate coupling attempts, such as a user from connecting user device 1400 to a foreign or improper accessory, the accessory coupling 1350 can comprise a male connector (e.g., 100) that is configured to merely, appropriately couple with a complementary female connector (e.g., 200). By way of example, a fuel source 1500 may be coupled with user device 1400 to provide fuel to the heater; and, using a female connector 200, an accessory hose can be coupled to the male connector 100 on the device 1400. In this way, the hose can be coupled to the accessory (e.g., using complementary couplers) such that the fuel source 1500 provides fuel to the accessory, through the heater.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A system for fluidly coupling a fluid source to a fluid use device, comprising:
a quick-connect first male fluid connector, comprising:
a first end and a second end opposite the first end; and
a first keyed feature comprising one or more ridges extending from the second end;
a quick-connect first female fluid connector, comprising:
a first end and a second end opposite the first end; and
a second keyed feature comprising one or more ridges disposed internal to the first end, wherein the second keyed feature is complementary to the first keyed feature such that merely the first female fluid connector can operably engage with the first male fluid connector to operably provide a sealed fluid coupling between the first male fluid connector and the first female fluid connector.

2. The system of claim 1, the first male fluid connector comprising a first valve and the first female fluid connector comprising a second valve, and the first and second valves operably disposed in an open position when the first female fluid connector is engaged with the first male fluid connector in fluid coupling.

3. The system of claim 1, the one or more ridges of the first keyed feature comprising a first annular-shaped wall, and the one or more ridges of the second keyed feature comprising a second annular-shaped wall, the first annular-shaped wall comprising a different diameter than the second annular-shaped wall.

4. The system of claim 3, the first annular-shaped wall comprising one of:
a larger diameter than the second annular-shaped wall, such that the second annular-shaped wall operably fits inside the first annular-shaped wall; and
a smaller diameter than the second annular-shaped wall, such that the first annular-shaped wall fits inside the second annular-shaped wall.

5. (canceled)

6. The system of claim 3, the first male fluid connector comprising a first valve and the first female fluid connector comprising a second valve, and one of the first valve and second valve comprising an elongate nose body that extends from the corresponding valve past the corresponding first or second wall.

7. The system of claim 6, the elongate nose body operably extending into the opposing first or second keyed feature to contact the opposing first or second valve when the first female fluid connector engages with the first male fluid connector.

8. The system of claim 1, the one or more ridges of the first keyed feature comprising one or more walls forming a first pattern, and the one or more ridges of the second keyed feature comprising one or more walls forming a second pattern, the first pattern complementary with the second pattern to allow the first female fluid connector to operably engage with the first male fluid connector in fluid coupling.

9. The system of claim 8, the one or more walls of the second pattern configured to operably fit inside the one or more walls of the first pattern.

10. The system of claim 1, comprising a fluid hose having the first female fluid connector disposed at a first end and a second male fluid connector disposed at a second end, the second male fluid connector comprising the first keyed feature.

11. The system of claim 10, comprising:
the fluid fuel source, the fluid fuel source comprising the first male fluid connector; and
the fluid fuel use device, the fluid fuel use device comprising a quick connect second female fluid connector, the second female fluid connector comprising the second keyed feature.

12. The system of claim 11, the fluid hose operably connecting the fluid fuel source to the fluid fuel use device, wherein the first male fluid connector operably couples to the first female fluid connector and the second female fluid connector operably couples to the second male fluid connector.

13. A method of coupling a fluid source to a fluid use device, comprising:
coupling a quick connect first male fluid connector with a quick connect first female fluid connector, the first male fluid connector comprising:
a first end and a second end opposite the first end; and
a first keyed feature comprising one or more ridges extending from the second end;
the first female fluid connector comprising:
a first end and a second end opposite the first end; and
a second keyed feature comprising one or more ridges disposed internal to the first end, wherein the second keyed feature is complementary to the first keyed feature such that merely the first female fluid connector can operably engage with the first male fluid connector to provide a sealed fluid coupling; and
coupling a quick connect second female fluid connector with a quick connect second male fluid connector, the second female connector comprising the second keyed feature, and the second male fluid connector comprising the first keyed feature;
wherein a fluid hose is disposed between the first female fluid connector and the second male fluid connector to operably, fluidly couple the first male fluid connector with second female fluid connector.

14. The method of claim 13, coupling the first male fluid connector with the first female fluid connector, wherein the one or more ridges of the first keyed feature comprise a first annular-shaped wall, and the one or more ridges of the second keyed feature comprise a second annular-shaped wall, and wherein the first annular-shaped wall comprises a different diameter than the second annular-shaped wall.

15. The method of claim 14, coupling the first male fluid connector with the first female fluid connector comprise engaging a first valve disposed in the first male fluid connector with a second valve disposed in the first female fluid connector, wherein one of the first valve and second valve comprising an elongate nose body that extends from the corresponding valve past the corresponding first or second wall.

16. The method of claim 15, the engaging of the first valve with the second valve comprising extending the elongate nose body into the opposing first or second keyed feature to contact the opposing first or second valve.

17. A system for fluidly coupling a fluid source to a fluid use device, comprising:
a quick-connect first male fluid connector; and
a quick-connect first female fluid connector complementary to the first male connector, wherein the first male connector can merely be coupled with the first female connector, the first male connector comprising a first keyed feature that engages with a complementary second keyed feature disposed in the first female connector, the first keyed feature and the second keyed feature are complementary to one another to mitigate coupling of the first male connector with a different female connector without the second keyed feature, and to mitigate coupling of the first female connector with the different male connector without the first keyed feature.

18. The system of claim 17, the first keyed feature comprising one or more ridges extending from a second end, and the second keyed feature comprising one or more ridges disposed internal to a first end.

19. The system of claim 18, the one or more ridges of the first keyed feature comprising a first annular-shaped wall, and the one or more ridges of the second keyed feature comprising a second annular-shaped wall, the first annular-shaped wall comprising a different diameter than the second annular-shaped wall.

20. The system of claim 19, the first annular-shaped wall comprising a larger diameter than the second annular-shaped wall, such that the second annular-shaped wall operably fits inside the first annular-shaped wall.
